(19) United States
(12) Patent Application Publication
(10) Pub. No.: US 2004/0208029 A1
(43) Pub. Date: Oct. 21, 2004

(54) METHOD AND APPARATUS FOR TRANSMITTING DATA

(76) Inventors: Michael A. Caruthers, Peoria, IL (US); Jeff Reichard, West Allis, WI (US)

Correspondence Address: Clifton G. Green, Caterpillar Inc., Intellectual Property Department, AB6490, 100 N.E. Adams Street, Peoria, IL, 61629-6490, US

(21) Appl. No.: 09/737,930

(22) Filed: Dec. 15, 2000

Related U.S. Application Data
(60) Provisional application No. 60/171,028, filed on Dec. 16, 1999.

(51) Int. Cl. H02M 1/00

(52) U.S. Cl. 363/72

(57) ABSTRACT

A circuit for transmitting data. A master controller circuit transmits a first data signal. N slave controller circuits are coupled with the master controller circuit. A first one of the n slave controller circuits is coupled with the master controller circuit to receive the first data signal, and determines a second data signal as a function of the first data signal, and transmits one of the first and second data signals as a function of a first flag signal. Each of the subsequent n−2 slave controller circuits are coupled with the respective previous slave controller circuit and receive the transmitted data signal from the previous slave controller circuit. Each of the subsequent n−2 slave controller circuits determines a subsequent data signal as a function of the transmitted data signal from the previous slave controller circuit, and transmits one of the transmitted data signal from the previous slave controller circuit and the determined subsequent data signal as a function of a respective flag signal. The n^{th} slave controller circuit is coupled with the master controller circuit, and with the n−1^{th} slave controller circuit to receive the transmitted signal from the n−1^{th} slave controller circuit. The n^{th} slave controller circuit transmits to the master controller the one of the transmitted data signal from the n−1^{th} slave controller circuit and the determined subsequent data signal as a function of an n^{th} flag signal.

This application claims the benefit of prior provisional patent application Serial No. 60/171,028, filed Dec. 16, 1999.

### TECHNICAL FIELD

This invention relates generally to the transmission of data, and more specifically, to the transmission of data between a master circuit and multiple slave circuits.

### BACKGROUND OF THE INVENTION

Many conventional power converter systems are modular. Several power converter modules are placed in parallel, with their respective outputs added together downstream. A slave controller is coupled with each power converter module, one slave controller per module, and controls the switching circuitry within the power converter module. A master controller is coupled with each slave, and transmits commands to the slave controllers, thereby adjusting the performance of each module. For example, the master controller may command one of the modules to go offline.

A conventional communication method between the master and slaves is a SPI data link, manufactured by Motorola. A conventional SPI data link uses four data lines: a clock line, a master out/slave in line, a master in/slave out line, and a slave select line, with the master controller connected directly with each slave. Thus, for example, when four power converter modules are used, 16 data lines (4 modules×4 lines each) are needed. Each of the data lines is typically a fiber optic cable, and may be quite expensive. Thus, the use of a conventional SPI data link and conventional master/slave communication architecture can be very expensive.

### SUMMARY OF THE INVENTION

The present invention provides apparatus and methods for transmitting data. A master controller circuit transmits a first data signal. N slave controller circuits are coupled with the master controller circuit. A first one of the n slave controller circuits is coupled with the master controller circuit to receive the first data signal, and determines a second data signal as a function of the first data signal, and transmits one of the first and second data signals as a function of a first flag signal. Each of the subsequent n−2 slave controller circuits are coupled with the respective previous slave controller circuit and receive the transmitted data signal from the previous slave controller circuit. Each of the subsequent n−2 slave controller circuits determines a subsequent data signal as a function of the transmitted data signal from the previous slave controller circuit, and transmits one of the transmitted data signal from the previous slave controller circuit and the determined subsequent data signal as a function of a respective flag signal. The n^{th} slave controller circuit is coupled with the master controller circuit, and with the n−1^{th} slave controller circuit to receive the transmitted signal from the n−1^{th} slave controller circuit. The n^{th} slave controller circuit transmits to the master controller the one of the transmitted data signal from the n−1^{th} slave controller circuit and the determined subsequent data signal as a function of an n^{th} flag signal.

### BRIEF DESCRIPTION OF THE DRAWINGS

FIG. 1 is a functional block diagram of a power transmission system according one embodiment of the invention.

FIG. 2 is a flow chart showing the logic of the master controller according to one embodiment of the invention.

FIG. 3 is a flow chart showing the logic of each slave controller circuit according to one embodiment of the invention.

### DETAILED DESCRIPTION OF THE INVENTION

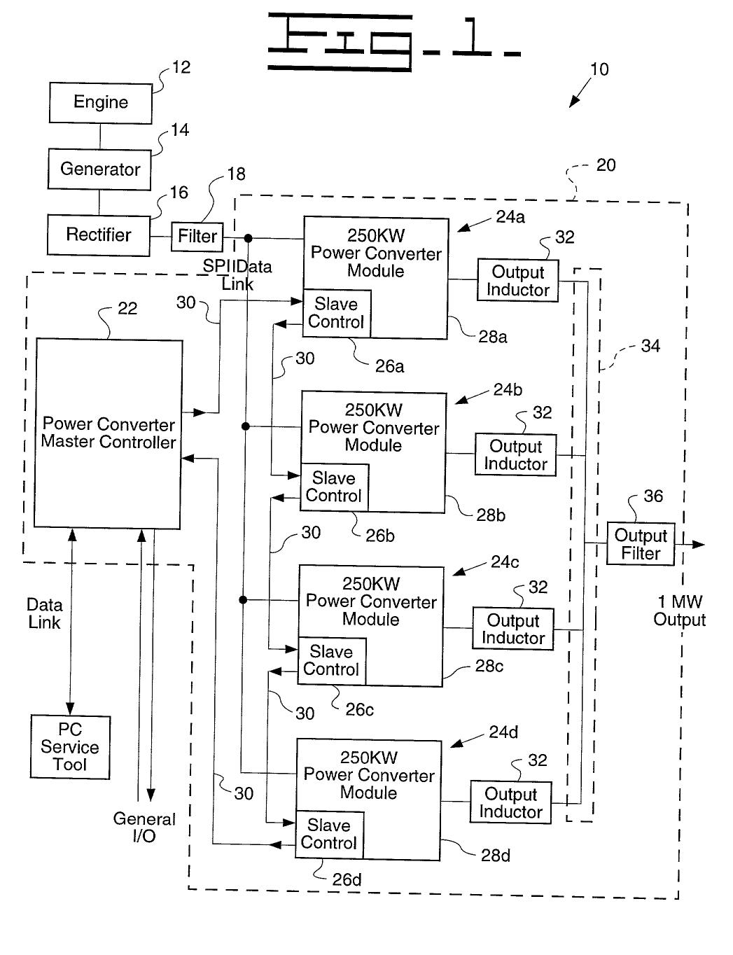

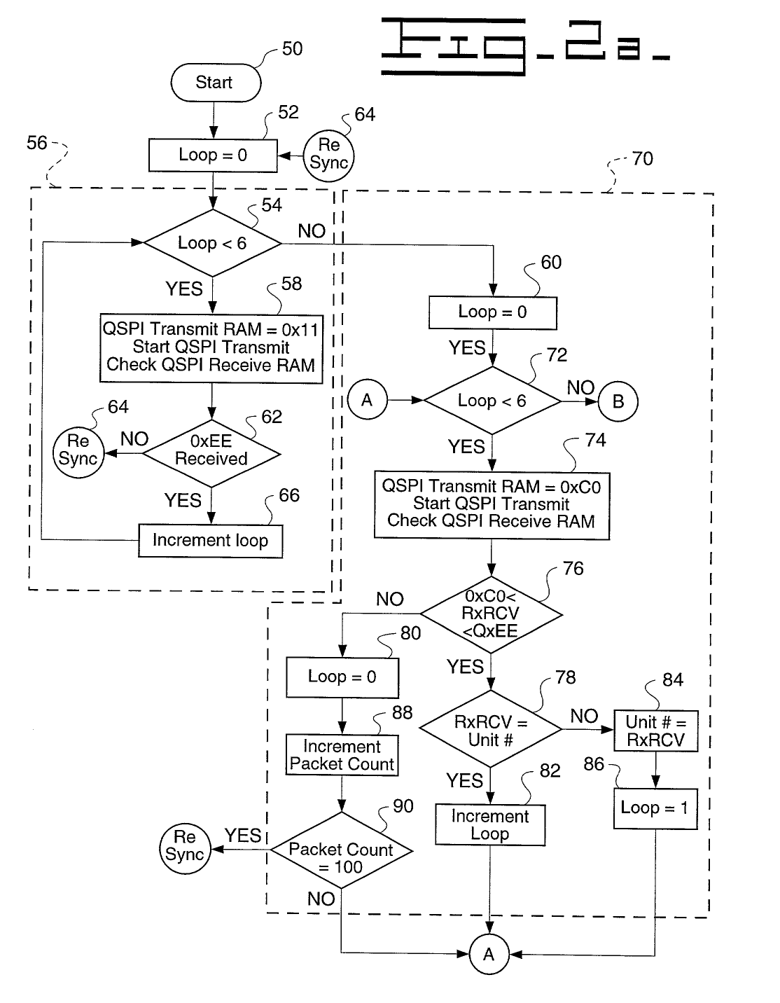

FIG. 1 is a functional block diagram of a power transmission system 10 according one embodiment of the invention. A motor, such as an engine 12, generates a rotary force by any of a variety of appropriate ways known to those skilled in the art. A generator 14 is coupled with the engine 12 to receive the rotary force. The generator 14 transmits a power signal, such as an alternating current (“AC”) power signal by any of a variety of appropriate ways known to those skilled in the art. The AC power signal is fed into a rectifier 16 that produces a direct current (“DC”) power signal by any of various ways known to those skilled in the art. The DC power signal is typically filtered by a filter 18 before being transmitted to a power converter system 20. The filter 18 may be any of a variety of appropriate filtering devices known to those skilled in the art.

The power converter system 20 includes a primary circuit, such as a controller circuit, such as a master controller 22, and a known number n of secondary circuits, such as power converter circuits 24. In one embodiment, n is equal to four. For simplicity, only four power converter circuits 24 are shown in FIG. 1, although the invention described herein can be easily applied to any power converter system 20 using more than one power converter circuit 24. In one embodiment, where n=4, each of the power converter circuits 24 transmits 250 kilowatts (“KW”); thus the power converter system 20 is rated for 1 megawatt (“MW”). Other power ratings may also be used, both by varying the amount of power transmitted by each power converter circuit 24, and by varying the number of power converter circuits 24.

The master controller 22 transmits a variety of data signals on a transmit line, such as initialization or command signals to the first power converter circuit 24a. Each power converter circuit 24 includes a slave controller circuit 26 and a power converter module circuit 28. In one embodiment the transmit line is a SPI data link 30 manufactured by Motorola and known to those skilled in the art is used to transmit the various signals between the master controller 22 and the slave controller circuit 26. Other appropriate data links

known to those skilled in the art may also be used. The SPI data link 30 may also be used to transmit data signals between the slave controller circuit 26 as described below.

The slave controller circuit 26a receives the data signal from the master controller 22 and typically transmits a subsequent data signal as a function of the received data signal on a slave transmit line, such as the SPI data link 30, as described below. In certain predetermined situations, the slave controller 26 may transmit data that is independent of the data signal from the master controller 22. For example, if a slave controller 26 detects a fault condition, the slave controller 26 will transmit a fault code, regardless of the data received from the master controller 22. In one embodiment, the slave controller circuit 26 typically operates in two modes: a looping mode and non-looping mode.

When operating in the looping mode, the slave controller 26 transmits whatever signal it receives on the SPI data link 30 from the previous circuit. For example, the slave controller circuit 26a would transmit the data signal received from the master controller 22, the slave controller 26b would transmit the data signal received from the slave controller circuit 26a, and so on. In one embodiment the last slave controller circuit, such as slave controller circuit 26d, transmits the data signal received from previous slave controller circuit 26, such as slave controller circuit 26c, to the master controller 22. Thus, the data signal transmitted by the master controller 22 “loops” through each of the slave controller circuit 26, and typically, although not necessarily always, returns to the master controller 22.

When operating in the non-looping mode, the slave controller circuit 26 transmits a signal determined by the slave controller circuit 26 as a function of the received data signal, i.e., some derivative signal, rather than transmitting the received data signal. In some embodiments, even when the slave controller circuit 26 is operating in the non-looping mode the slave controller circuit 26 may transmit a signal that is equal to or equivalent with the received data signal. This, however, is typically due to the particular logic of the slave controller circuit 26, and not because the slave controller circuit 26 is operating in the looping mode.

In one embodiment, the slave controller 26 operates in a third mode, and error mode for example. When operating in the third mode, the slave controller 26 may transmit its own data as a function of the internal logic of the slave controller 26. For example, the slave controller 26 may override the normally transmitted data with a fault code signal when an error is detected.

The embodiments described above may offer cost savings when compared with a conventional power converter system 20. Because the data signal transmitted by the master controller 22 may loop through each of the slave controller circuits 26, the master controller 22 need not have a separate data line directly coupling the master controller with each of the slave controller circuits 26. This may lead to either a reduction in the number of data lines 30 in the power converter system 20, or depending upon the geometry of the power converter system 20, to a reduction in the total length of the data lines 30. These reductions typically reduce the costs of the power converter system 20.

During normal operation, the slave controller circuit 26 transmits switching signals (not shown) to the power converter module circuit 28. The switching signals cause the power converter module circuit 28 to transmit a power signal, such as a pulse with modulated (“PWM”) by ways known to those skilled in the art. For simplicity, only a single-phase power converter system 20 is discussed and shown, although embodiments of the invention are equally applicable to multi-phase power converter systems, as would be apparent to those skilled in the art.

In one embodiment, a conversion circuit, such as an output inductor 32 is coupled with the power converter module circuit 24 to receive the PWM signal. The output inductor 32 transmits a current signal that is a function of the integral of the received PWM signal. Typically a single output inductor 32 receives the PWM signal for one phase of the power transmitted by the power converter circuit 24. Thus, for three phase power applications, three output inductors would typically be used per power converter circuit 24.

A summer, such as a node 34, receives the current signals from all of the output inductors 32 for a particular phase of power, and transmits an AC signal, such as a sine wave, as a function of the sum of the received current signals. Typically the AC signal is equal to the sum of the current signals. Although a node 44 is shown, other summing circuits known to those skilled in the art may also be used.

In one embodiment, an output filter 36 is coupled with the node 34 to receive the sine wave. The output filter 36 smoothes the sine wave 48, removing some of a ripple current that is typically present in the output of the node 34, thereby more closely approximating an ideal sine wave.

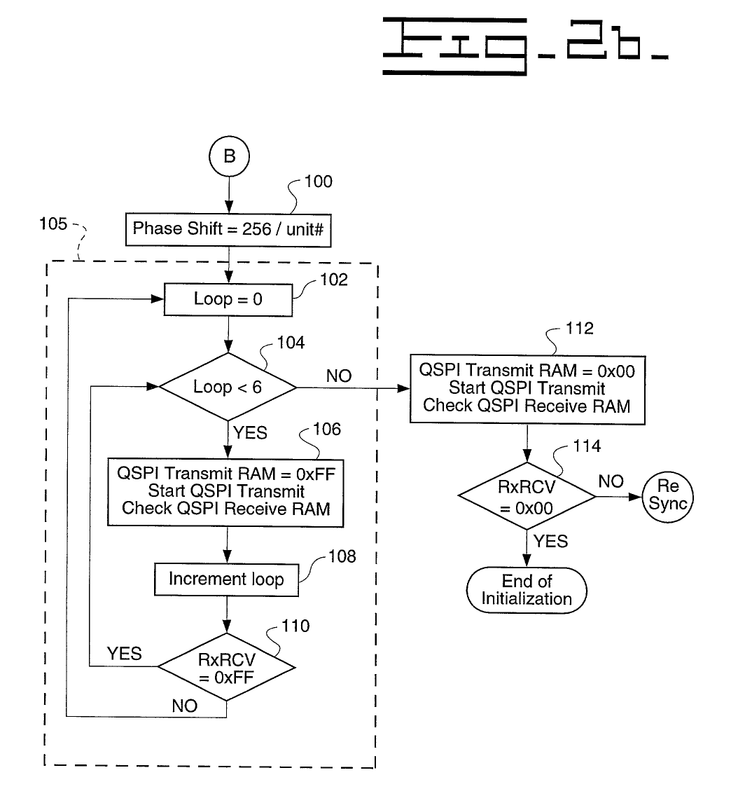

The operation of the power converter circuit system 20 according to one embodiment of the invention will now be described in more detail. Upon start-up, such as a power-up, the power converter system 20 performs an initialization. FIG. 2 is a flow chart showing the logic of the master controller 22 according to one embodiment of the invention. The master controller 22 enters an initialization mode in block 50. In block 52 the master controller 22 sets a loop counter to a first predetermined number, such as zero. Other predetermined numbers may also be used as appropriate.

In block 54 the loop counter is compared with a second predetermined number, such as six. Other predetermined numbers may also be used as appropriate. The second predetermined number is typically selected so as to require an Initialize Communications Link logic 56 to be performed a significant number of times. This ensures consistent, and therefore presumably correct, operation of the power converter system 20. If the loop counter is less than six, consistent results have not been verified, and therefore control transfers to block 58. If the loop counter is equal to or greater than six, control transfers to block 60.

In block 58 the master controller 22 transmits a third predetermined value, such as hex value 11 (shown as 0x11) on the SPI data link 30 to the first slave controller circuit 26a. The master controller 22 typically transmits in sync with a clock signal (not shown). The master controller 22 then waits until it receives data from the last slave controller circuit 26d. When the master controller 22 receives data from the slave controller circuit 26d, control transfers to block 62.

In block 62 the data received from the last slave controller circuit 26d is compared with a fourth predetermined value, such as hex EE. The fourth predetermined value is typically a value that represents successful data transfer from the master controller 22 to each of the slave controller circuits 26. If the data is not equal to EE, control transfers to block 64, thereby restarting the initialize communications link logic 56. If the data is equal to EE, control transfers to block 66.

In block 66 the loop counter is increment and by a predetermined value, such as one. Control then transfers back to block 54.

As mentioned above, when the loop counter is greater than six, the master controller 22 has received confirmation six times that the data transmitted to the slave controller circuits 26 was successfully received by the slave controller circuits 26. This tells the master controller 22 that each of the slave controller circuits 26 is receiving the data correctly.

In one embodiment, the master controller 22 automatically determines the number of power converter circuits 24 being used by the power converter system 20 in Determine # logic 70 after performing the Initialize Communications Link logic 56.

In block 60 the loop counter is reset to a predetermined number, such as zero.

In block 72 the loop counter is compared with a predetermined number, such as six. Other predetermined numbers may also be used as appropriate. The predetermined number is typically selected so as to require a Determine # logic 70 to be performed a significant number of times. This ensures consistent, and therefore presumably correct, operation of the power converter system 20. If the loop counter is less than six, consistent results have not been verified, and therefore control transfers to block 74. If the loop counter is equal to or greater than six, control transfers to block 100.

In block 74 the master controller 22 transmits a predetermined value, such as hex C0 on the SPI data link 30 to the first slave controller circuit 26a. Again, the transmission of the predetermined value is typically done in sync with a clock signal. The master controller 22 than waits until it receives a data signal from the last slave controller circuit 26d.

In block 76 the master controller 22 compares the data signal RxRCV received from the last slave controller circuit 26d with two predetermined values, such as C0 and EE. If the data signal RxRCV received has a predetermined relationship with the two predetermined values, for example is greater than C0 and less than EE, control transfers to block 78. The data signal RxRCV received from the last slave controller circuit 26d typically corresponds to the number of slave controller circuits being used within the power converter system 20. The two predetermined values (C0 and EE) are typically selected to have a difference in magnitude sufficient to be at least equal to the total possible number of slave controller circuits 26 that would likely be used within the power converter system 20. The number of slave controller circuits 26 may be typically determined by the expected power requirements of a typical power converter system 20. If the data signal RxRCV received from the last slave controller circuit 26d is not between the two predetermined values (C0 and EE), control transfers to block 80.

In block 78, the data signal RxRCV is compared with another predetermined value (UNIT#). Typically UNIT# is some initialized value, usually equal to the expected number of slave controller circuits 26 within the power converter system 20. In another embodiment, UNIT# is not pre-defined. Instead, for example, a value received by the master controller 22, such as from the last slave controller circuit 26 is assigned to UNIT#. If the data signal RxRCV is equal to UNIT#, control transfers to block 82. If the data signal RxRCV is not equal to UNIT#, control transfers to block 84.

In block 82 the loop counter is increment and by predetermined value, such as one, and control transfers back to block 72.

In block 84 UNIT# is set equal to the received data signal RxRCV.

In block 86 the loop counter is reset to a predetermined number, such as one, and control is transferred back to block 72. Loop counter is set to 1 rather than 0 because the data signal RxRCV has been received once. Thus, the data signal RxRCV must be received only five more times (with a value equal to the value just received) in order to reach the number of consecutive repetitions (six) required by block 72.

Blocks 80, 88, and 90 are timeout logic. In block 80 the loop counter is reset to a predetermined value, such as zero. In block 88 PACKET COUNT is incremented from a predetermined initialized value, such as zero. In block 90, PACKET COUNT is compared with a predetermined value, such as one hundred. If PACKET COUNT is equal to one hundred, a data signal RxCV has been received one hundred times, each time being outside of the expected value from block 76 (between C0 and EE). This typically means that an error has occurred, and thus control transfers back to block 64 begin again. If the packet count is not equal to one hundred (and thus is presumably less than one hundred) control transfers back to block 72 to continue the Determine # logic 70.

In certain embodiments, it may be desirable to have each of the power converter modules 28 staggered (i.e., out of phase) by an equal amount. Block 100 determines the amount of phase shift PHASE SHIFT between each power converter module 28. Typically, the phase shift will equal 360 degrees divided by the number UNIT# of power converter modules 28. However if a digital communications protocol is used, the phase shift may be represented by a full-scale value, such as 256 for an 8 bit system. Thus PHASE SHIFT would equal 256/UNIT#. Other mathematical relationships between the outputs of the power converter modules 28 may also be effected by ways known to those killed in the art by using appropriate logic in block 100.

In block 102 loop counter is reset to a predetermined value, such as zero.

In block 104 the loop values compared with another predetermined value, such as six. Again, other predetermined numbers may also be used as appropriate. The predetermined number is typically selected so as to require a Set Slave to Non-Loop Mode logic 105 to be performed a significant number of times. This ensures consistent, and therefore presumably correct, operation of the power converter system 20. If the loop counter is less than six, consistent results have not been verified, and therefore control transfers to block 106. If the loop counter is equal to or greater than six, control transfers to block 112.

In block 106, the master controller 22 transmits a predetermined data signal, such as hex FF to the first slave controller circuit 26a via the SPI data link 30. The master controller 22 then waits to receive a data signal RxCV from the last slave controller circuit 26d. When a data signal RxCV from the last slave controller circuit 26d is received, control transfers to block 108.

In block 108 the loop counter is increment and by predetermined amount, such as one.

In block 110 the data signal RxCV is compared with a predetermined value, such as the value (FF) transmitted by the master controller 22. If the data signal RxCV is equal to the value (FF) transmitted by the master controller 22, transfer controls back to block 104. If the data signal RxCV is not equal to the value (FF) transmitted by the master controller 22, an error has likely occurred, and transfer controls back to block 102 to begin the Set Slave to Non-Loop Mode logic 105 again.

Control is transferred to block 112 after the master controller 22 has received six consecutive values of FF, thereby indicating, as shown below, that each of the slave controller circuits 26a has entered the looping mode, as described above. In block 112 master controller transmits a data signal, such as hex 00, that will cause the slave controller circuits 26 to exit the initialization process, as shown below. The master controller 22 then waits until it receives a data signal RxCV from the last slave controller 26d.

In block 114 the received data signal RxCV from the last slave controller 26d is compared with a predetermined value, such as the value (00) just transmitted by the master controller 22. If the received data signal RxCV is equal to 00, then each of the slave controller circuits 26 has exited the initialization process, and normal operation of the power conversion system 10 may begin. If the received data signal RxCV is not equal to 00, an error has occurred, and control transfers back to block 64 to begin the initialization process again.

Although described as a linear path, each of the initialization software routines 56, 70, 105 may be ignored (i.e., not performed) as appropriate.

Thus, in one embodiment of the invention, during system initialization, the master controller 22 continuously transmits 11 until it receives six consecutive values of EE. The master controller 22 then continuously transmits a value of C0 until it receives six equal values between C0 and EE. The master controller 22 stores this value as the number of power converter module circuits 24 in the power converter system 20. The master controller then continuously transmits a value of FF until it receives six consecutive values of FF. Then master controller 22 then sends a value of 00, signaling the end of the initialization process.

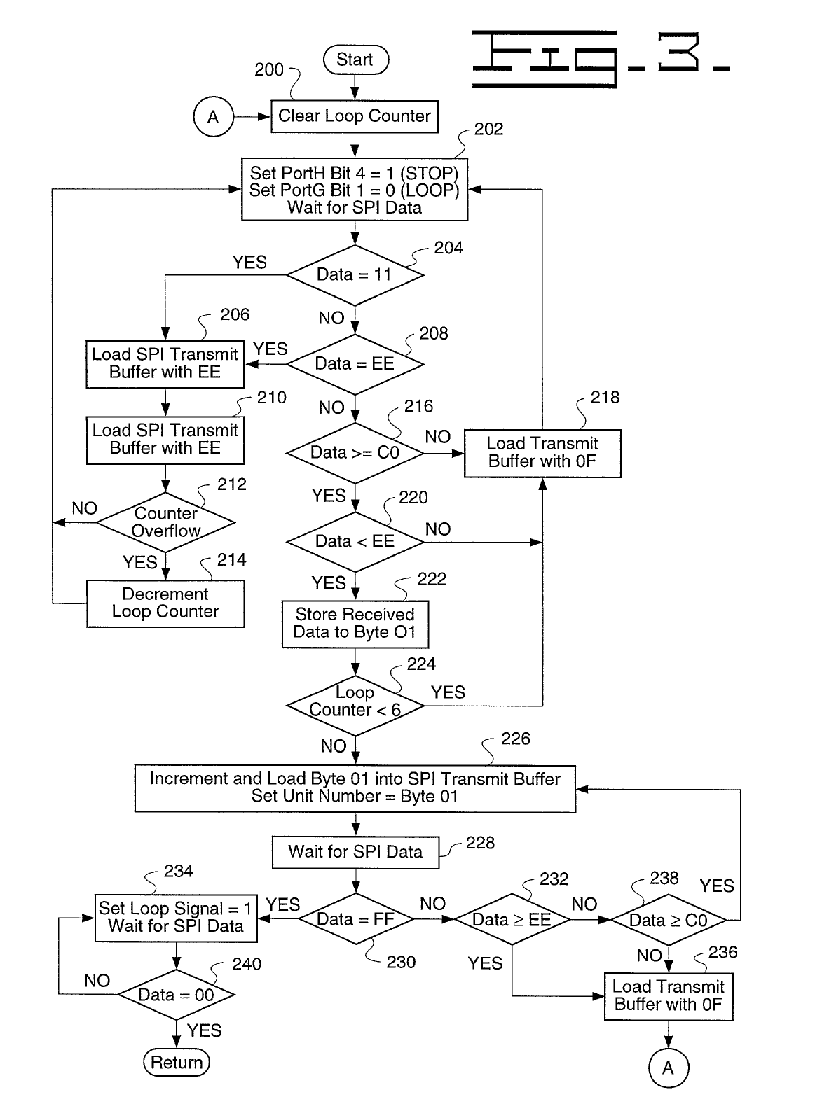

FIG. 3 is a flow chart showing the logic of each slave controller circuit 26 according to one embodiment of the invention. In block 200 the slave controller circuit 26 clears a loop counter.

In block 202 the slave controller circuit 26 sets a variable LOOP equal to a predetermined value, such as zero. When LOOP is equal to zero, the slave controller circuit 26 operates in the non-looping mode, as described above. When LOOP is equal to a second predetermined value, such as one, the slave controller circuit 26 operates in the looping mode, as described above. The slave controller circuit 26 then waits to receive data from the previous circuit, e.g., the master controller 22 in the case of the first slave controller circuit 26a, or a previous slave controller circuit 26a-c in the case of the slave controller circuit 26b-d other than the first, as shown in FIG. 1.

If the slave controller circuit 26 receives the 11 data signal, or another predetermined value as described above, control transfers to block 206. If the received data signal does not equal 11, control transfers to block 208. If a 11 data signal was received, this indicates that the master controller 22 has begun the Initialize Communications link logic 56, and that the slave controller circuit 26 is the first slave controller circuit 26a.

In block 206 the slave controller circuit 26 loads the SPI transmit buffer with a predetermined value, such as EE. This value will be transmitted automatically on the next clock signal to the next circuit in the power converter system 20, e.g., either another slave controller circuit 26, or the master controller 22. As described above, if the master controller 22 receives an EE during the Initialize Communications link logic 56, the loop counter will be incremented in block 66.

In block 210 the loop counter is incremented by a predetermined value, such as one.

In block 212 loop counter is checked to see if an overflow has occurred. If an overflow has occurred, control transfers to block 214. If an overflow has not occurred, control transfers back to block 202.

In block 214 the loop counter is decremented by a predetermined value, such as one. Control then transfers back to block 202.

Blocks 212 and 214 may be used as error correction logic, and may be removed from the slave controller circuit logic in some embodiments of the invention without unduly affecting the remainder of the logic. If for example, an improper value, such as a number greater than 6, is written to a memory location that stores the loop counter value, block 212 will detect this. Block 214 will then begin to correct the error by decrementing the counter towards a value of six. If the loop counter value were to improperly be above six, the slave controller circuit 26 may prematurely transfer control to block 226.

As mentioned above, if the data received by the slave controller circuit 26 is not equal to 11 in block 204, control transfers to block 208. In block 208 the data received by the slave controller circuit 26 is compared with EE. If the data received equals EE and the master controller 22 is performing the Initialize Communications link logic 56, then typically the slave controller circuit 26 is not the first slave controller circuit 26a, and control transfers to block 206. If the data received does not equal EE, control transfers to block 216.

In block 216 the data is compared with another predetermined value, such as C0 (from block 76). If at this point the data received is not greater than or equal to C0, then an error has likely occurred, and control transfers to block 218. If the data received is greater than or equal to C0, control transfers to block 220.

In block 218 the transmit buffer of the slave controller circuit 26 is loaded with a predetermined value outside of the predetermined values of block 76 (C0 and EE), such as 0F. This value will be automatically transmitted to the next circuit, e.g., the master controller 22 or another slave controller circuit 26, on the next clock signal. The master controller 22 typically ultimately receives the 0F, which will likely cause the master controller 22 to restart the initialization process as a result of either block 62 or block 90, as described above.

In block 220 the data received is compared with another predetermined value, such as EE (from block 76). If at this point the data received is not less than EE, then an error has likely occurred, and control transfers to block 218. If the data received is less than EE, control transfers to block 222.

In block 222 the received data signal is stored in a memory location, such as byte 01.

In block 224 loop counter is compared with a predetermined number, such as six. Under normal operation, the loop counter will have been incremented six times in block 210 (because the master controller 22 transmits 11 six times in block 58, or the previous slave controller (if any) has transmitted EE six times). If this is not the case, an error has likely occurred. Thus, control transfers to block 218. If the loop counter is greater than or equal to six, control transfers to block 226.

In block 226 the data value stored in Byte 01 is incremented by a predetermined value, such as one, and loaded into the transmit buffer of the slave controller circuit 26. This incremented value is automatically transmitted to the next circuit on the next clock signal. The unit indicator of the slave controller circuit 26 is set to equal the value stored in Byte 01. Control then transfers to block 228.

In block 228 slave controller circuit waits for the next data signal from the previous circuit.

In block 230 slave controller circuit 26 compares the just received data signal with the predetermined value from block 106 (FF). If the received data signal does not equal FF, control transfers to block 232, and if it does equal FF, to block 234.

In block 232 the slave controller circuit compares the just received data signal with one of predetermined values from block 76 (EE). If the just received data signal is greater than or equal to EE, an error has likely occurred, and control transfers to block 236. An error has likely occurred because at this point, the slave controller expects to receive a data signal indicative of the number of (preceding) slave controller circuits 26 between itself and the master controller 22. The data signal should therefore be between C0 and EE. If the just received data signal is not greater than or equal to EE, control transfers to block 238.

In block 236 the transmit buffer of the slave controller circuit 26 is loaded with an error code, such as 0F. The error code is automatically transmitted to the next circuit on the next clock signal, and ultimately to the master controller 22. As discussed above, the master controller 22 typically restarts the appropriate logic routine as a function of receiving the error code.

In block 238 the just received data signals compared with the other of the predetermined values from block 76 (C0). If the just received data signal is greater than or equal to C0, control transfers to block 226, and if not, to block 236. Again, at this point the slave controller circuit 26 expects to receive a data signal indicative of the number of (preceding) slave controller circuits 26 between itself and the master controller 22. The data signal should therefore be between C0 and EE (non-inclusive). If the data signal received is greater than or equal to C0, the initialization process is therefor operating normally.

In block 234 LOOP is set to a second predetermined value, such as one. As discussed above, when LOOP equals 1, the slave controller circuit 26 operates in the looping mode. The slave controller circuit 26 then waits to receive the next data signal. At this point the slave controller circuit 26 has completed its portion of the initialization process, and is waiting for a command from the master controller 22 to exit the initialization process.

In block 240, the next received data signal is compared with the predetermined value from block 112 (00). If the received data signal is not equal to 00, control transfers back to block 234, placing the slave controller circuit 26 back in a wait state. If the received data signal is equal to 00, the slave controller 26 exits the initialization process.

Thus, in one embodiment of the invention, the slave controller circuits 26 have the capability to transmit data to other downstream slave controller circuits 26 and to the master controller 22, or to allow the data from the master controller 22 to loop through all of the slave controller circuits 26 and then back to the master controller 22. When LOOP is set to 0, the slave controller circuit 26 operates in the former state, and when LOOP is set to 1, the slave (preceding) slave controller circuits 26 between itself and the master controller 22. The data signal should therefore be between C0 and EE (non-inclusive). If the data signal received is greater than or equal to C0, the initialization process is therefor operating normally.

In block 234 LOOP is set to a second predetermined value, such as one. As discussed above, when LOOP equals 1, the slave controller circuit 26 operates in the looping mode. The slave controller circuit 26 then waits to receive the next data signal. At this point the slave controller circuit 26 has completed its portion of the initialization process, and is waiting for a command from the master controller 22 to exit the initialization process.

In block 240, the next received data signal is compared with the predetermined value from block 112 (00). If the received data signal is not equal to 00, control transfers back to block 234, placing the slave controller circuit 26 back in a wait state. If the received data signal is equal to 00, the slave controller 26 exits the initialization process.

Thus, in one embodiment of the invention, the slave controller circuits 26 have the capability to transmit data to other downstream slave controller circuits 26 and to the master controller 22, or to allow the data from the master controller 22 to loop through all of the slave controller circuits 26 and then back to the master controller 22. When LOOP is set to 0, the slave controller circuit 26 operates in the former state, and when LOOP is set to 1, the slave controller circuit 26 operates in the latter state. During initialization, the slave controller circuit 26 first sets LOOP equal to 0. If the slave controller circuit 26 receives 11 or EE it transmits an EE to the next slave. If the slave controller receives a value between C0 and ED, the slave controller circuit 26 increments this value and stores this value as UNIT#, and transmits UNIT# to the next slave controller circuit 26. The slave controller circuit 26 then waits to receive a value of FF. When the slave controller circuit 26 receives FF, it sets LOOP equal to 1, which allows the data from the master controller 22 to loop through to all of the other slave controller circuits 26. The slave controller circuit then waits to receive 00, which indicates the end of the initialization process.

One embodiment of the present invention may be used in conjunction with embodiments of the invention disclosed in “Method and Apparatus for Transmitting Power” by Mike Caruthers and Jeff Reichard, filed the same day as the present application, and which is hereby incorporated by reference.

The above discussion is not intended to imply that embodiments of the invention must be implemented exclusively with either hardware or software. In appropriate situations, one or the other, or both may be used. The word “circuit” is intended to describe both software and hardware, with software being, in effect, a temporary circuit.

From the foregoing it will be appreciated that, although specific embodiments of the invention have been described herein for purposes of illustration, various modifications may be made without deviating from the spirit and scope of the invention. For example, certain blocks or functions may be omitted, or the order of certain logic (subroutines) may be changed. Accordingly, the invention is not limited except as by the appended claims.

What is claimed is:

1. An apparatus for transmitting data, comprising:
a power converter master controller circuit operable to transmit a first data signal; and
n power converter slave controller circuits,
a first one of the n slave controller circuits coupled with the master controller circuit to receive the first data signal, the first slave controller operable to determine a second data signal as a function of the first data signal and operable to transmit one of the first and second data signals as a function of a first flag signal,
each of the subsequent n−2 slave controller circuits coupled with the respective previous slave controller circuit and operable to receive the transmitted data signal from the previous slave controller circuit, to determine a subsequent data signal as a function of the transmitted data signal from the previous slave controller circuit, and to transmit one of the transmitted data signal from the previous slave controller circuit and the determined subsequent data signal as a function of a respective flag signal,
the n^{th} slave controller circuit being coupled with the master controller circuit, and with the n−1^{th} slave controller circuit to receive the transmitted signal from the n−1^{th} slave controller circuit, the n^{th} slave controller circuit operable to transmit to the master controller the one of the transmitted data signal from the n−1^{th} slave controller circuit and the determined subsequent data signal as a function of an n^{th} flag signal.

2. The apparatus of claim 1 wherein the first data signal comprises an initialization signal.

3. The apparatus of claim 1 wherein n is equal to four.

4. The apparatus of claim 1 wherein the n slave controller circuits are operable to transmit the respective determined data signal when the respective flag signal has a first characteristic and are operable to transmit the respective received data signal when the flag signal has a second characteristic.

5. The apparatus of claim 4 wherein the flag signal has the first characteristic when the flag signal comprises one of a zero and a one and has the second characteristic when the flag signal comprises the other of the zero and the one.

6. An apparatus for transmitting data, comprising:
a master controller circuit operable to transmit a data signal on a master controller circuit transmit line; and
n slave controller circuits, a first one of the n slave controller circuits coupled with the transmit line of the master controller circuit to receive the first data signal, the first slave controller circuit operable to process and transmit a processed data signal on a first slave controller transmit line as a function of the first data signal;
each of the subsequent n−2 slave controller circuits coupled with the transmit line of the respective previous slave controller circuit to receive the transmitted data signal from the previous slave controller circuit, and to process and transmit a respective processed data signal on a respective slave controller transmit line as a function of receiving the transmitted data signal from the previous slave controller circuit;
the n^{th} slave controller circuit being coupled with the master controller circuit, and with transmit line of the n−1^{th} slave controller circuit to receive the transmitted data signal from the n−1^{th} slave controller circuit, the n^{th} slave controller circuit operable process and transmit to the master controller circuit a processed data signal as a function of the received data signal.

7. The apparatus of claim 6 wherein the processed signal from each slave controller circuit comprises the data signal received from the previous circuit.

8. The apparatus of claim 6 wherein each processed signal comprises the respective received data signal incremented by a predetermined amount.

9. The apparatus of claim 8 wherein the predetermined amount equals one.

10. The apparatus of claim 6 wherein the master controller circuit is operable to adjust its operating characteristics as a function of the signal received from the n^{th} slave controller circuit.

11. The apparatus of claim 6 wherein the master controller circuit is operable to determine the number of slave controller circuits as a function of the signal received from the n^{th} slave controller circuit.

12. The apparatus of claim 6 wherein the slave controller circuits are operable to respectively transmit PWM signals, and the master controller circuit is operable to cause the slave controller circuits to create respective out of phase PWM signals, the PWM signals being out of phase by approximately 360/n.

13. The apparatus of claim 6 wherein the master controller circuit comprises a power converter master controller and the slave controller circuits comprise power converter slave controller circuits.

14. The apparatus of claim 6 wherein each of the slave controller circuits is operable to determine a derivative signal as a function of the data signal received from the previous circuit, and the respective slave controller circuit transmits one of the data signal received from the previous circuit and the derivative signal as the respective processed signal as a function of a respective flag signal.

15. The apparatus of claim 14 wherein the flag signal comprises a loop signal.

16. An apparatus for initializing a modular power converter system, comprising
a master controller circuit operable to transmit a first data signal, to transmit a second data signal as a function of receiving a first response signal, to transmit a third data signal as a function of receiving an incremented second response signal, to store the incremented second response signal, and to transmit a fourth data signal as a function of receiving a third response signal; and
n serially linked slave controller circuits respectively having a receive line and a transmit line, the receive line from the first slave controller circuit being coupled with the master controller circuit, the receive line of each subsequent slave controller circuit being coupled with the respective transmit line of the previous slave controller circuit, and the transmit line of the n^{th} slave controller circuit being coupled with the master controller circuit, the n slave controller circuits operable to enter an initialization mode upon activation, and when in the initialization mode, each of the n slave controller circuits is operable
to set a loop signal to a first value, the slave controller operable to transmit a signal determined by the respective slave controller circuit on the transmit line when the loop signal has the first value,
to transmit the first response signal on the transmit line as function of receiving either the first data signal or the first response signal when the loop signal has the first value,
to increment the second data signal and to transmit the incremented second data signal on the transmit line as a function of receiving one of the second data signal and the incremented second data signal when the loop signal has the first value,
to store the respective incremented second data signal as a respective unit number,
to set the loop signal to a second value in response to receiving the third data signal, the slave controller circuit operable to transmit the signal received on its respective receive line on the transmit line as a function of the loop signal having the second value,
to transmit the third response signal on the transmit line as a function of receiving the third data signal,
to transmit the fourth data signal on the respective transmit line as a function of receiving the fourth data signal when the loop signal has the second value,
and to exit the initialization mode as a function of receiving the fourth data signal.

17. The apparatus of claim 16 wherein the master controller is operable to repeatedly transmit the first data signal, and the master controller is operable to stop the transmission of the first data signal upon consecutive receipt of the first response signal m times,
repeatedly transmit the second data signal, and the master controller is operable to stop the transmission of the second data signal upon
consecutive receipt of the incremented response signal having equal characteristics n times, and
repeatedly transmit the third data signal, and the master controller is operable to stop the transmission of the third data signal upon consecutive receipt of the third response signal p times.

18. The apparatus of claim 17 wherein m, n, and p are equal to six.

19. The apparatus of claim 16 wherein the first data signal comprises a signal that begins an initialization process.

20. The apparatus of claim 16 wherein the incremented second data signal comprises a signal representative of the number of slave controller circuits through which the second data signal and the incremented second data signal have been transmitted.

21. The apparatus of claim 16 wherein the fourth data signal comprises a signal operable to cause the slave controller to exit an initialization process.

22. An apparatus for transmitting data, comprising:
a power converter master controller circuit operable to transmit a first data signal on an SPI data link;
a first power converter slave controller circuit coupled with the power converter master controller circuit to receive the first data signal, the first power converter slave controller operable to determine a second data signal as a function of the received data signal and operable to transmit the first data signal when a first loop signal has a first value and to transmit the second data signal when the first loop signal has a second value;
a second power converter slave controller circuit coupled with the first power converter slave controller circuit to receive the one of the first and second data signals, second power converter slave controller circuit operable to determine a third data signal as a function of the received data signal and operable to transmit the data signal received by the second power converter slave controller circuit when a second loop signal has a first value and to transmit the third data signal when the second loop signal has a second value;
a third power converter slave controller circuit coupled with the second power converter slave controller circuit to receive one of the third data signal and the data signal received by the second power converter slave controller circuit, the third power converter slave controller circuit operable to determine a fourth data signal as a function of the received data signal and operable to transmit the data signal received by the third power converter slave controller circuit when a third loop signal has a first value and to transmit the fourth data signal when the third loop signal has a second value; and
a fourth power converter slave controller circuit coupled with the third power converter slave controller circuit to receive one of the fourth data signal and the data signal received by the third power converter slave controller circuit, the fourth power converter slave controller circuit operable to determine a fifth data signal as a function of the received data signal and operable to transmit the data signal received by the fourth power converter slave controller when a fourth loop signal has a first value and to transmit the fifth data signal when the fourth loop signal has a second value, the transmitted signal being transmitted to the master controller circuit on the SPI data link.

23. An apparatus for transmitting power, comprising:
an engine operable to transmit a rotary force;
a generator coupled with the engine to receive the rotary force, the generator operable to transmit an A.C. signal as a function of the rotary force;
a rectifier circuit coupled with the generator to receive the A.C. signal, the rectifier circuit operable to transmit a D.C. signal as a function of the A.C. signal;
a power converter master controller circuit operable to transmit a command signal on a transmit line;
n power converter slave controller circuits,
a first one of the n power converter slave controller circuits coupled with the transmit line of the master controller circuit to receive the command signal, the first power converter slave controller circuit operable to transmit a first switching signal as a function of the command signal, and to transmit the command signal on a first slave transmit line,
each of the subsequent n−2 slave controller circuits coupled with the transmit line of the respective previous power converter slave controller circuit to receive the command signal from the previous power converter slave controller circuit, each of the subsequent n−2 power converter slave controllers operable to transmit a respective switching signal as a function of the command signal, and to transmit the command signal on a respective slave controller transmit line,
the n^{th} power converter slave controller circuit being coupled with the power converter master controller circuit, and with transmit line of the n−1^{th} power converter slave controller circuit to receive the command signal from the n−1^{th} power converter slave controller circuit, the n^{th} power converter slave controller circuit operable transmit an n^{th} switching signal as a function of the command signal and to transmit the command signal to the power converter master controller circuit;
n power converter module circuits respectively coupled with the rectifier circuit to receive the D.C. signal and with the n power converter slave circuits to receive the n switching signals, the n power converter module circuits operable to respectively transmit n pulse width modulated signals as a function of the n switching signals and the D.C. signal, the n pulse width modulated signals being out of phase by approximately 360/n degrees.
n conversion circuits respectively coupled with the n power converter module circuits to respectively receive the n pulse width modulated signals and operable to produce n current signals as a function of the respective n pulse width modulated signals; and
a summer coupled with the n conversion circuits to receive the n current signals, the summer operable to transmit an AC signal as a function of the sum of the n current signals.

24. The apparatus of claim 23 wherein each of the conversion circuits comprises an inductor.

25. The apparatus of claim 23 wherein each of the n current signals approximately comprises the integral of the respective n pulse width modulated signals.

26. The apparatus of claim 23 wherein the AC signal comprises a sine wave.

27. The apparatus of claim 23 wherein the summer comprises a node.

28. A method for transmitting data between a master circuit and n slave circuits, comprising:
coupling the master circuit and n slave circuits in series;
determining a characteristic of n loop signals, each respective loop signal corresponding to a respective slave circuit;
passing a received signal from a previous circuit in series to a next circuit in series when the respective loop signal for the respective slave circuit has a respective first characteristic; and
determining a respective secondary signal as a function of a received signal from a previous circuit when the respective loop characteristic has a respective second characteristic; and
transmitting the respective secondary signal to the next circuit in series when the respective loop signal has a respective second characteristic.

29. The method of claim 28 wherein the last slave circuit is coupled with the master circuit.

30. The method of claim 28 wherein the respective loop signal has the first characteristic when the loop signal comprises a respective first value and has the second characteristic when the loop signal comprises a respective second value.

31. A method for determining the number of secondary circuits, comprising:
coupling the primary circuit and n secondary circuits in a loop;
transmitting a data signal from the primary circuit to the first secondary circuit in the loop;
passing the data signal received from each previous circuit in the loop to a next circuit in the loop, each secondary circuit incrementing the data signal by a predetermined amount; and
determining the number of secondary circuits as a function of the data signal received by the primary circuit.

32. The method of claim 31 wherein the predetermined number is one.

33. The method of claim 31 wherein the primary circuit comprises a power converter master controller circuit and the secondary circuit comprises a power converter slave controller circuit.
